(19) United States
(12) Patent Application Publication
(10) Pub. No.: US 2019/0059210 A1
(43) Pub. Date: Feb. 28, 2019

(54) Fertilizer Cage Apparatus

(71) Applicant: Wow Product Sales, LLC, Fenton, MI (US)

(72) Inventor: David M. Allen, Fenton, MI (US)

(21) Appl. No.: 16/119,512

(22) Filed: Aug. 31, 2018

Related U.S. Application Data
(60) Provisional application No. 62/552,533, filed on Aug. 31, 2017.

(51) Int. Cl. A01C 15/02; A01G 29/00

(52) U.S. Cl. CPC A01C 15/02; A01G 29/00

(57) ABSTRACT

A fertilizer cage apparatus comprising an elongated body that has an upper end and a lower end, an outer surface and an inner surface, the inner surface defining an elongated channel. The elongated body further comprises a spike portion and a central portion. The spike portion is at the lower end, and a broadening region adjacent the spike portion. The central portion has a base wall and at least one axially outward wall projection. At least one of the base wall and the at least one axially outward wall having at least one opening. The base wall defines a central portion of the inner elongated channel with the axially outward wall projection defining a longitudinal channel of the inner elongated channel. The fertilizer cage receives a fertilizer spike within the central portion. A method of use is also disclosed.

### CROSS-REFERENCE TO RELATED APPLICATION

This application claims priority from U.S. Pat. App. Ser. No. 62/552,533, entitled “Fertilizer Cage Apparatus” filed Aug. 31, 2017, the entire disclosure of which is hereby incorporated by reference in its entirety.

### BACKGROUND OF THE DISCLOSURE

### 1. Field of the Disclosure

The disclosure relates in general to landscaping provisions, and more particularly, to a cage that can receive fertilizer and which can be buried in the ground. Such a configuration facilitates the passage of air and water to the fertilizer to enhance the dissolution and spreading of the fertilizer to the ground nearby.

### 2. Background Art

The use of fertilizer is known in the art. Among other types of fertilizer, fertilizer spikes for trees and shrubs is known. For example, it is known to drive fertilizer spikes around a tree or shrub to provide nourishment to the plant. In many configurations, spikes are driven around the tree in varying configurations or through varying spacing.

In many instances, such spikes comprise composite devices that include fertilizer. In many configurations, such spikes have the strength and structure to be nailed into the ground (often when a polymer cap is positioned over the structure). Such spikes then dissolve slowly over time, and the nutrients therein spread through the ground.

Problematically, in many instances, the spikes lack sufficient strength to be pounded into the ground. For example, in some situations the spikes break or disintegrate as they are being inserted into the ground. Among other deficiencies, the spikes are often driven into the ground and contact the ground therearound quite tightly. As such, it is often difficult to have water and air reach much of the surface area of the spike, thereby reducing the speed at which the fertilizer dissolves or spreads to the root system.

### SUMMARY OF THE DISCLOSURE

The disclosure is directed to a fertilizer cage apparatus comprising an elongated body. The elongated body has an upper end and a lower end, an outer surface and an inner surface, the inner surface defining an elongated channel. The elongated body further comprises a spike portion and a central portion. The spike portion is at the lower end, and a broadening region adjacent the spike portion. The central portion has a base wall and at least one axially outward wall projection. At least one of the base wall and the at least one axially outward wall having at least one opening. The base wall defines a central portion of the inner elongated channel with the axially outward wall projection defining a longitudinal channel of the inner elongated channel. The fertilizer cage is configured to receive a fertilizer spike within the central portion, and wherein the fertilizer cage is structurally configured to be inserted into an outside surface.

In some configurations, the base wall of the central portion defines a generally circular configuration.

In some configurations, the base wall has a diameter which is smaller than a diameter of the broadening region.

In some configurations, the at least one axially outward wall projection has a diameter substantially matching the diameter of the broadening region.

In some configurations, the at least one axially outward wall projection including a plurality of openings in communication with the longitudinal channel created thereby.

In some configurations, the base wall includes a plurality of openings in communication with the inner elongated channel created thereby.

In some configurations, the fertilizer cage further includes an upper portion positioned proximate the upper end of the elongated body. The base wall and the at least one axially outward wall extend radially outwardly within the upper region.

In some configurations, the upper portion defines a diameter with the diameter of the upper portion extending radially beyond the diameter of the broadening region.

In some configurations, the spike portion comprises a conical spike extending from a cylindrical member, being substantially centrally located.

In some configurations, the broadening region further includes a plurality of openings extending therethrough.

In some configurations, the broadening region has a substantially hemispherical configuration.

In some configurations, the at least one axially outward wall projection defines a substantially triangular cross-sectional configuration.

In another aspect of the disclosure, the disclosure is directed to a combination spike and fertilizer cage having a fertilizer cage as disclosed herein, with the spike comprising a cylindrical member.

In some configurations, the spike has a lower end, an upper end and an outer surface. The outer surface of the spike substantially following the outer surface of the base wall.

In another aspect of the disclosure, the disclosure is directed a method of utilizing a fertilizer cage comprising the steps of: providing a fertilizer cage having an inner elongated channel including a central portion and at least one longitudinal channel; inserting a fertilizer spike within the central portion; inserting the fertilizer cage into an outside surface, such as the ground; allowing water and oxygen to extend along the at least one longitudinal channel; and dissolving the fertilizer spike, to, in turn, deliver nutrients to the outside surface.

In some configurations, the step of inserting the filter spike further comprises the step of: pushing the outside surface away from the fertilizer cage by a broadening region, such that the outside surface is loosened proximate the central portion of the elongated body.

In some configurations, the central body and the at least one longitudinal channel include openings placing the outside surface and the longitudinal channel in fluid communication. The step of allowing further comprising the step of: passing fluid through the openings and into the outside surface.

### BRIEF DESCRIPTION OF THE DRAWINGS

The disclosure will now be described with reference to the drawings wherein:

FIG. 1 of the drawings is a perspective of the fertilizer cage showing, in particular, the axially outward wall protrusions and openings, along with a fertilizer spike positioned therein;

FIG. 2 of the drawings is a perspective cross-sectional side view of the fertilizer cage showing, in particular, the fertilizer spike within the inner elongated channel of the cage with a fertilizer spike positioned therein;

FIG. 3 of the drawings is a cross-sectional view view of the fertilizer cage taken perpendicular to the axis of the elongated body and through the central portion with a fertilizer spike positioned therein;

FIG. 4 of the drawings is an partial perspective view of the fertilizer cage, with the fertilizer spike removed, showing, in particular, the longitudinal channels of the cage.

FIG. 5 of the drawings is a partial perspective view of the fertilizer cage, with the fertilizer spike removed, showing, in particular, the piercing tip and broadening region of the spike portion to the fertilizer cage.

### DETAILED DESCRIPTION OF THE DISCLOSURE

While this disclosure is susceptible of embodiment in many different forms, there is shown in the drawings and described herein in detail a specific embodiment(s) with the understanding that the present disclosure is to be considered as an exemplification and is not intended to be limited to the embodiment(s) illustrated.

It will be understood that like or analogous elements and/or components, referred to herein, may be identified throughout the drawings by like reference characters. In addition, it will be understood that the drawings are merely schematic representations of the invention, and some of the components may have been distorted from actual scale for purposes of pictorial clarity.

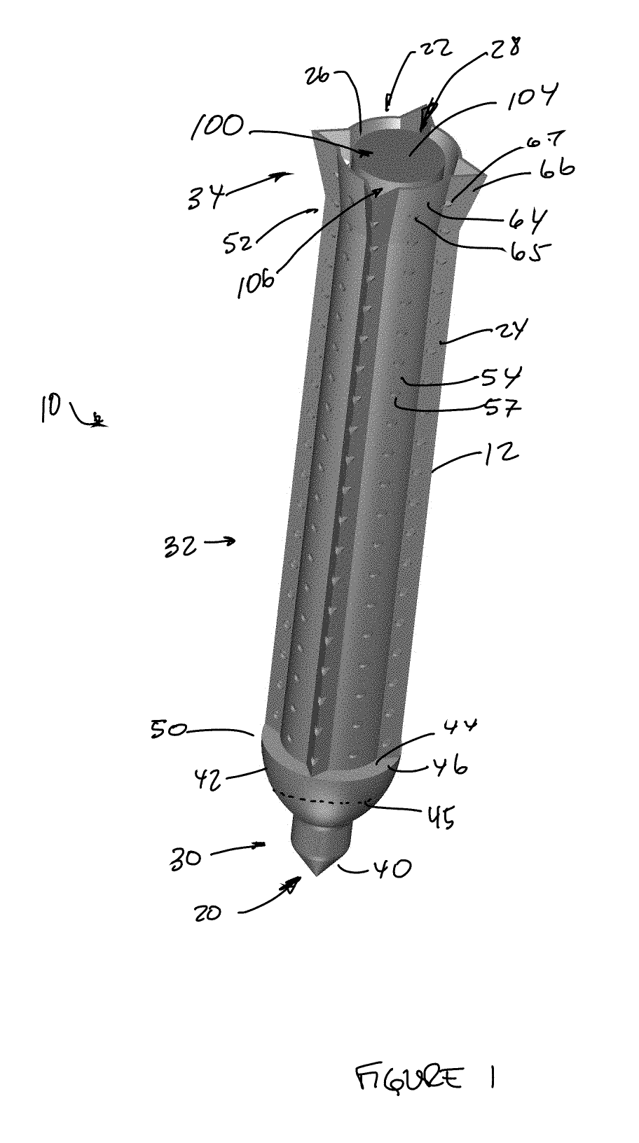

Referring now to the drawings and in particular to FIG. 1, the fertilizer cage apparatus is shown generally at 10. The fertilizer cage 10 comprises an elongated body 12, spike portion 30, central portion 32, and upper portion 34. It is contemplated by the present disclosure that the fertilizer cage 10 may be constructed of various materials including, but not limited to, moldable plastic, manufacturable ceramics, or other such materials. Further, the fertilizer cage 10 is contemplated to have varying sizes including, but not limited to, wall thickness, length, and width of the defined channels. That is, it can be changed in size and shape to accommodate various types of fertilizer sticks.

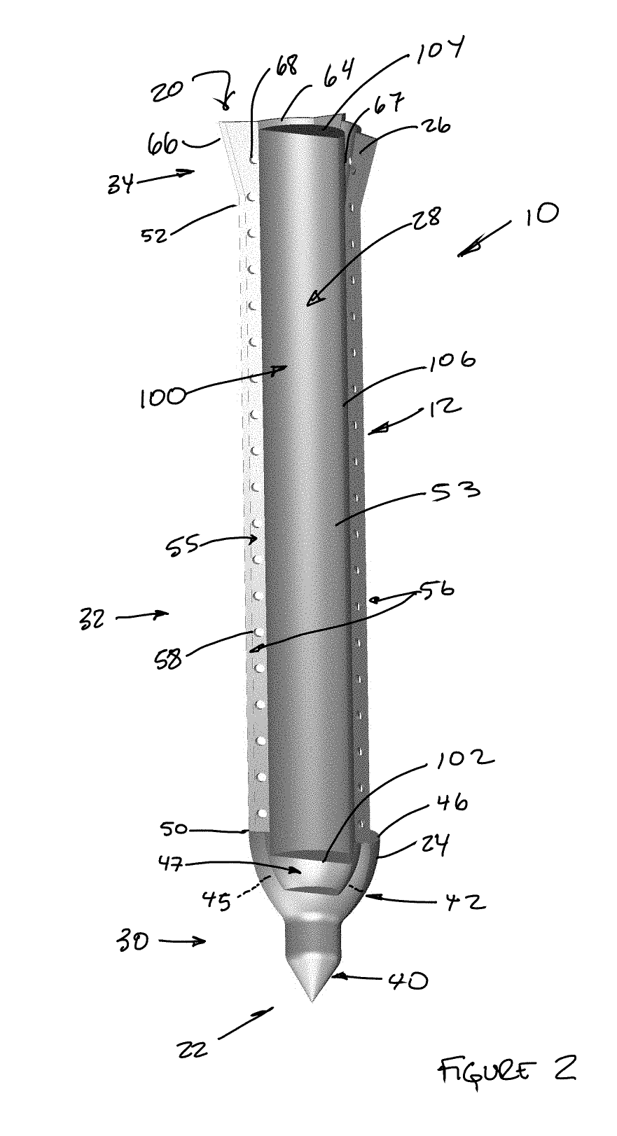

The elongated body 12, show in FIGS. 1 and 2, comprises an upper end 20, lower end 22, outer surface 24, and inner surface 26. The upper end 20 and lower end 22 are opposite one another with the outer surface 24 and inner surface 26 extending between both ends. The inner surface 26 is opposite the outer surface 24 and separated by a thickness that is variable and subject to change in contemplated configurations. The inner elongated channel 28 is defined by the cavity between the inner surface 26 and extends substantially from the upper end 20 towards the lower end 22. The depth of the inner elongated channel 28 is variable and subject to change in contemplated configurations.

It is contemplated that the elongated body 12 is substantially uniform in thickness. In the configuration shown, the wall separation between the outer surface 24 and inner surface 26 are substantially uniform. In contemplated configurations, the uniformity of the design may be altered to best match the desired use of the fertilizer cage 10. This change may include, but is not limited to, the thickness of the walls about a specific side, end, depth of the inner elongated channel, or other such alterations to the design.

It is contemplated that the elongated body is rigid and may comprise a material suitable for prolonged environmental contact. Such a material, preferably has some level of rigidness such that the inner elongated channel 28 remains structurally sound when the cage is pushed or hammered into the ground.

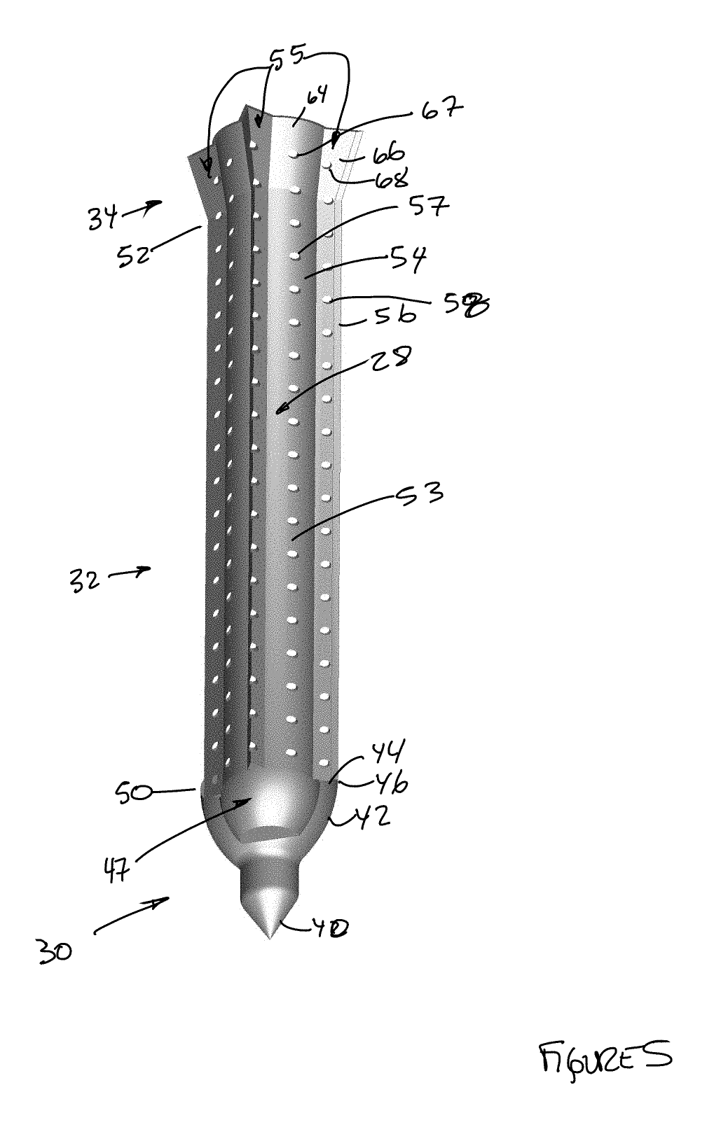

Show in FIGS. 1 and 5, the spike portion 30 comprises piercing tip 40, broadening region 42. The broadening region further comprises an upper edge 44, openings 45, and outer perimeter 46. The broadening region defines a lower portion 47 of the inner elongated channel 28. The broadening region 42 extends from the upper edge 44 to the piercing tip 40 at a distance that is variable and subject to change in contemplated configurations. The outer perimeter 46 is defined by the upper edge 44. Further, in the configuration shown, the upper edge 44 is substantially parallel in reference to the upper end 20 of the elongated body 12 and, preferably is larger, in this case in diameter (as the base wall 64 defines a circle) relative to the base wall 64. Openings 45, indicated in FIG. 1, comprise holes of substantial enough size to allow liquid movement therethrough. The orientation and size of the openings 45 are variable and subject to change in contemplated configurations. In other configurations, the openings may be omitted entirely.

In the exemplary configuration, the piercing tip 40 comprises a pointed cone, having a substantially small surface area (i.e., a pointed tip) at the lowest region to allow penetration into the ground. In contemplated configurations, the length, depth, reduction in perimeter length may change. For example, the shape may be altered from a conical shape to a reduced single sharp point. Further, the length of the piercing tip 40 and the material it is thereby made from may be altered to best suit contemplated uses of the fertilizer cage 10.

The broadening region 42 of the exemplary figure is shown to be hemispherical in the configuration. This shape may be the hemispherical shape shown, but may also be shapes including, but not limited to, conical, It is along this region that the openings 45 may be present in a size variable and subject to change in contemplated configurations.

The central portion 32, shown in FIGS. 1 and 5, comprises lower end 50, upper end 52, base wall 54, and axially outward wall projections 56. The base wall further comprises openings 57 and central portion channel 53 of the inner elongated channel 28. The axially outward wall projections 56 comprise openings 58 and define longitudinal channels 55 of the inner elongated channel 28. It is to be understood the base wall 54 extends from lower end 50 the upper end 52, where the lower end 50 and upper end 50 are substantially opposite and parallel in reference to one another. The height of base wall 52, and thereby distance between the lower end 50 and upper end 52, is variable and subject to change in contemplated configurations. In the exemplary figure, openings 57 are present about the base wall 54 that allow movement of substantially smaller materials between the inner surface 26 and outer surface 24. Or, as may be inferred by those with sufficient knowledge in the field, access from the exterior of the fertilizer cage 10 to the central portion channel 53 of the inner elongated channel 28.

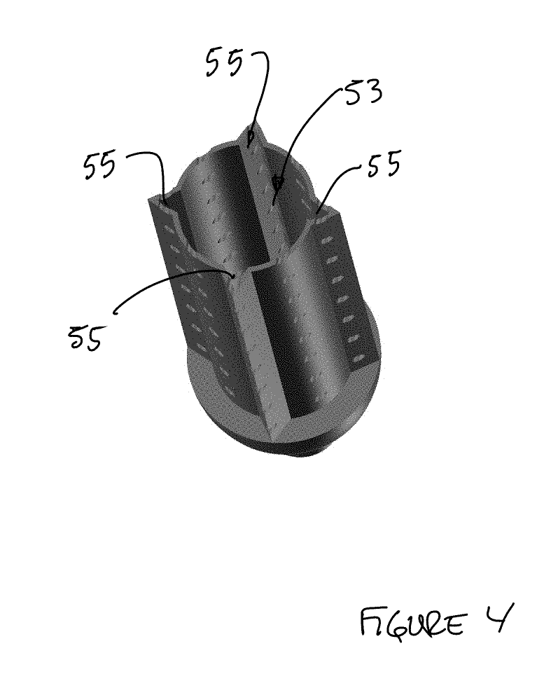

Further, the axially outward wall projections 56 extend from lower end 50 to upper end 52. In the exemplary figure, there are four axially outward wall projections 56 with openings 58 about the fertilizer cage 10. The number of axially outward wall projections 56 is variable and subject to change in contemplated configurations. Shown exemplary in FIG. 4, The longitudinal channels 55 of the inner elongated channel 28 are defined by the projections 56. In the configuration shown, the projections have a cross-sectional area that comprises a triangular configuration wherein the third side is open to the central portion of the inner elongated channel. The dimensions, including, but not limited to, the thickness, depth, and width of the longitudinal channels 55 are variable and subject to change in contemplated configurations.

It is to be understood the openings 57, 58 of the central portion 32 are of variable size, number, and orientation and subject to change in contemplated configurations. That is to say, with reference to the exemplary figures, the openings 57, 58 may be increased or decreased in number, given larger or smaller sizes, be placed further apart or closer together, or any combination therein. Openings 57, 58 may overlap between the base wall 54 and axially outward wall projections 56 as is seen in the exemplary figure, or specifically FIGS. 1 and 5. The thickness of base wall 54 and axially aligned wall projections 56 is substantially uniform in the exemplary figure, but may be subject to alterations in contemplated configurations including, but not limited to, thicker bottom portions, thicker upper portions, thinner central portions, or combinations therein.

The base wall 54 is configured to have a footprint that is smaller than that of the broadening region 42 of the spike portion. In the configuration shown, the base wall 54 comprises a circular cross-sectional configuration and the broadening region comprises a circular cross-sectional region which has a diameter that is greater than that of the base wall. In the configuration shown, the cross-sectional length of the base wall plus the opposing axially outward wall projections generally matches the diameter of the broadening region. As such, when inserted into the ground, the broadening region will push away the soil and an air space (or loose soil) will fill the region between the soil and the base wall. This will further aid in the passage of water and air out of the inner elongated channel and into the soil. Further, the openings 57, 58 of the central portion may be of similar size or greater in comparison to the openings 45 of the spike portion 30. Variability in ratio of sizes of the openings of the spike portion 30 and central portion 32 are subject to change in contemplated configurations.

In the configuration shown, a total of four axially outward wall projections are shown, essentially disposed in a uniform spaced apart configuration wherein one axially outward wall projection is positioned each quarter turn of the elongated body. Additionally, the projections are all substantially straight (i.e., not helical or wound) and extend substantially parallel to a central axis of the inner elongated channel. The outward projection of the projections facilitates the straight insertion of the cage into the ground, and may preclude rotation or tilting thereof, as the projections may act like little vanes or guides.

It is further contemplated that while four equally spaced projections are shown, it is contemplated that the projections may be other than equally spaced about the central portion. Additionally, it is contemplated that such projections may be helical, curved or otherwise other than helically wound. Furthermore, it is contemplated that while four projections are shown, a greater or lesser number of projections are contemplated, such as, for example, between two and ten projections (or even fewer or greater). Additionally, varying cross-sectional configurations are contemplated for each of the projections, and each of the projections may be the same or may have a different cross-sectional configuration. Additionally, while the projections are shown as extending from the lower end to the upper end of the central portion (and into the upper portion), the projections may stop short of one or both of the lower end and the upper end.

As shown in FIGS. 1, 2, and 5, the upper portion 34 comprises base wall 64 and axially outward wall projections 66. The base wall 64 comprises openings 67 and the axially outward wall projections 66 comprises openings 68. The upper portion 34 extends from the upper end 52 of the central portion 32 to a variable distance that may change in contemplated configurations. It is to be understood the upper portion 34, including the base wall 64 and axially outward wall projection 66, expand radially outward as the distance from the central portion 32 increases. The rate of radial increase is variable within the design and may change in both a uniform and ununiform rate. Such a widening allows a user to grasp and retain the fertilizer spike to remove the same, and also provides a centering to the spike to facilitate insertion.

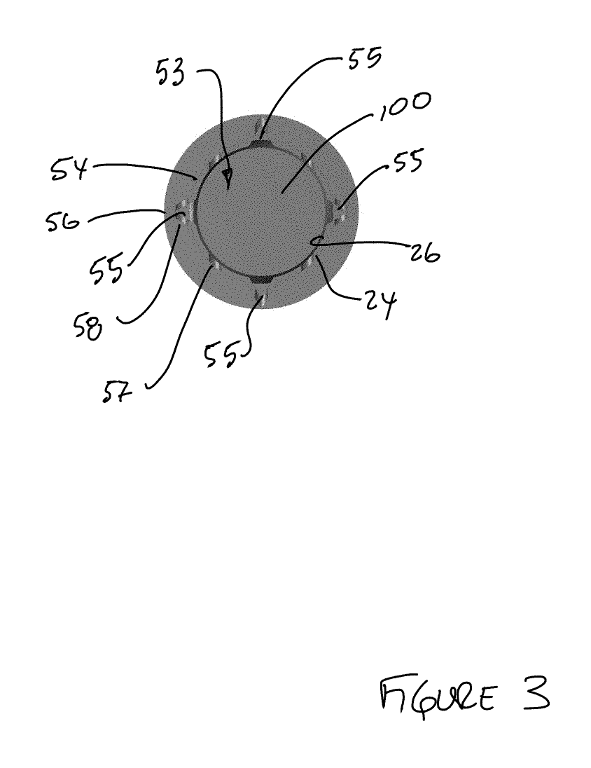

Shown in FIGS. 1-3, the fertilizer spike 100 comprises a lower end 102, upper end 104, and outer surface 106. The lower end 102 and upper end 104 are substantially opposite one another, with the outer surface 106 extended between the two ends. The fertilizer spike 100 has lower end 102 placed within the inner elongated channel 28 of the elongated body 12 such that it is closer to the lower end 22 than the upper end 104. The outer surface 106 of the fertilizer spike 100 is of a height that is substantially equal to or substantially smaller than the length of the inner elongated channel 28. It is to be understood the fertilizer spike 100 is of slightly smaller size than the inner elongated channel 28 to allow the fertilizer spike 100 to be placed (i.e., slid) axially within the channel.

It is known to those with ordinary skill in the art that the fertilizer spike 100 is made of a different material than the fertilizer cage 10 and is separate from the module. The fertilizer spike 100 may be made out materials that are biodegradable in nature or practice. Additives to provide structure and the like are contemplated as are other ingredients, such as surfactants and dyes. It is contemplated that the fertilizer spike may have configurations and ingredients different than those that are hammered into the ground, as the force exerted to drive the cage and spike into the ground (where they are mated before being driven into the ground) is now handled by the fertilizer cage instead of being completely borne by the fertilizer spike.

In operation of the configuration shown, the fertilizer spike 100 is placed within the inner elongated channel 28 axially in such a way that the upper end 104 of the fertilizer spike 100 is generally fully inserted into the inner elongated channel. In other configurations, the fertilizer spike may extend beyond the upper end of the elongated body. Additionally, the outer surface 106 of the fertilizer spike will be slightly separated from the inner surface 26 of the upper portion 34 of the fertilizer cage or may abut the same. At the upper portion, the base wall expands so that there is sufficient room to allow a user to both insert and pull out the fertilizer spike from the elongated body. The dimensions may vary between contemplated configurations and desired uses of the device. While a single fertilizer spike is shown, it is contemplated that a plurality of fertilizer spikes may be inserted that are each of a smaller size such that they can all fit within the inner elongated channel.

Once assembled, the fertilizer cage and stick is positioned on an outside surface (such as on the ground formed from dirt) at an appropriate location so that material therefrom can be directed to the roots of a tree or shrub. In many instances, this occurs in what is known as a drip zone of a tree or along the drip zone of a tree or shrub (while not required). More particularly, the spike portion 30 is placed atop the dirt with the piercing tip pointed at the surface. The surface may be made of such things including, but not limited to, soil, compost, mulch, or other surfaces that may hold vegetation and may be at least partially porous to liquids. Once aligned, an external tool, such as a hammer or mallet may be used to force the fertilizer cage 10 into said surface. Where the surface is very soft, a user may be able to push the cage into the ground without a tool. In other instances, where the ground is very hard, it may be necessary to dig a hole with a shovel or a pick to reduce the amount of time necessary to insert the cage into the described surface.

Once placed within the surface as desired, a liquid, such as water through watering, sprinkling, raining or the like, may move through the surface reach the fertilizer cage 10 having the fertilizer spike 100. The water can be directed along the axially outward projections, and through the longitudinal channels 55 so as to direct water, in the configuration shown, to four different sides of the fertilizer spike, and, along substantially the entire length thereof. Furthermore, such a configuration allows oxygen to also extend down the longitudinal channels. Such passage of water and air along the length of the central portion and along the length of at least portions of the fertilizer spike enhances the dissolution of the fertilizer spike, improving the releasing of the materials and components therein and the direction thereof to the nearby areas.

More specifically, the released material moves through openings 45, 57, 58, 67, 68 and into the surrounding area. The beneficial materials may include oxygen or other such chemicals or compounds. It is to be noted the openings 45, 57, 58, 67, 68 are designed in such a way to prevent clogging during the decomposition of the fertilizer spike 100, thus allowing substantially uninterrupted dispersal of the fertilizer spike 100 compounds to the surrounding surface outside the fertilizer cage 10. By including the axial projections and the base wall, the region immediately surrounding the central portion will preferably become quite loose or may include substantial voids therebetween so as to facilitate the passage of the nutrients through the ground to the roots. Opening 45 substantially preclude the pooling of water within the inner elongated channel about the lower end 22 of the elongated body 12.

It is to be understood the fertilizer cage may be present within the determined surface for a variable amount of time depending upon the materials of the fertilizer spike 100, the period between watering and subsequent dissolving of the material, the size of the stick, and other factors related to the longevity of fertilizer. It is known by those with ordinary skill in the art that the fertilizer cage is designed to receive subsequent fertilizer spikes as the prior fertilizer spike fully disintegrates. Alternatively, the spike can be removed from the ground as desired.

The foregoing description merely explains and illustrates the disclosure and the disclosure is not limited thereto except insofar as the appended claims are so limited, as those skilled in the art who have the disclosure before them will be able to make modifications without departing from the scope of the disclosure.

What is claimed is:

1. A fertilizer cage apparatus comprising:
an elongated body having an upper end and a lower end, an outer surface and an inner surface, the inner surface defining an elongated channel, the elongated body further comprising:
a spike portion at the lower end, and a broadening region adjacent the spike portion;
a central portion having a base wall and at least one axially outward wall projection, at least one of the base wall and the at least one axially outward wall having at least one opening, the base wall defining a central portion of the inner elongated channel with the axially outward wall projection defining a longitudinal channel of the inner elongated channel,
wherein the fertilizer cage is configured to receive a fertilizer spike within the central portion, and wherein the fertilizer cage is structurally configured to be inserted into an outside surface.

2. The fertilizer cage apparatus of claim 1 wherein the base wall of the central portion defines a generally circular configuration.

3. The fertilizer cage apparatus of claim 2 wherein the base wall has a diameter which is smaller than a diameter of the broadening region.

4. The fertilizer cage apparatus of claim 3 wherein the at least one axially outward wall projection has a diameter substantially matching the diameter of the broadening region.

5. The fertilizer cage apparatus of claim 3 wherein the at least one axially outward wall projection including a plurality of openings in communication with the longitudinal channel created thereby.

6. The fertilizer cage apparatus of claim 5 wherein the base wall includes a plurality of openings in communication with the inner elongated channel created thereby.

7. The fertilizer cage apparatus of claim 1 further comprising an upper portion positioned proximate the upper end of the elongated body, wherein the base wall and the at least one axially outward wall extend radially outwardly within the upper region.

8. The fertilizer cage apparatus of claim 7 wherein the upper portion defines a diameter with the diameter of the upper portion extending radially beyond the diameter of the broadening region.

9. The fertilizer cage of claim 1 wherein the spike portion comprises a conical spike extending from a cylindrical member, being substantially centrally located.

10. The fertilizer cage of claim 9 wherein the broadening region further includes a plurality of openings extending therethrough.

11. The fertilizer cage of claim 10 wherein the broadening region has a substantially hemispherical configuration.

12. The fertilizer cage of claim 1 wherein the at least one axially outward wall projection defines a substantially triangular cross-sectional configuration.

13. A combination spike and fertilizer cage having the fertilizer cage of claim 1, with the spike comprising a cylindrical member.

14. The combination spike and fertilizer cage wherein the spike has a lower end, an upper end and an outer surface, the outer surface of the spike substantially following the outer surface of the base wall.

15. A method of utilizing a fertilizer cage comprising the steps of:
providing a fertilizer cage having an inner elongated channel including a central portion and at least one longitudinal channel defined by an axially outward wall projection;
inserting a fertilizer spike within the central portion;
inserting the fertilizer cage into an outside surface, such as the ground;
allowing water and oxygen to extend along the at least one longitudinal channel; and
dissolving the fertilizer spike, to, in turn, deliver nutrients to the outside surface.

16. The method of claim 15 wherein the step of inserting the filter spike further comprises the step of:
pushing the outside surface away from the fertilizer cage by a broadening region, such that the outside surface is loosened proximate the central portion of the elongated body.

17. The method of claim 15 wherein the central body and the at least one longitudinal channel include openings placing the outside surface and the longitudinal channel in fluid communication, with the step of allowing further comprising the step of:
passing fluid through the openings and into the outside surface.
